(19) United States
(12) Patent Application Publication
(10) Pub. No.: US 2011/0153388 A1
(43) Pub. Date: Jun. 23, 2011

(54) SYSTEM AND METHOD FOR COLLECTING END USER FEEDBACK FOR STATIONERY DESIGNS

(76) Inventors: MAX VUONG, San Jose, CA (US); Roger Hong, Mountain View, CA (US); Grace Han, Sunnyvale, CA (US)

(21) Appl. No.: 12/641,132

(22) Filed: Dec. 17, 2009

(51) Int. Cl. G06Q 10/00; G06Q 50/00; G06F 3/048

(52) U.S. Cl. 705/7.32; 715/760; 715/838; 705/12

(57) ABSTRACT

A system and method are described for collecting user feedback on prospective stationery designs. For example, one embodiment of a system implemented within an online stationery service for collecting user feedback on prospective stationery designs is described, the system comprising at least one memory for storing program code and at least one processor for processing the program code to execute: session management logic to establish and maintain an online session with an end user; a voting module to implement a screening test to determine an association between the user and a particular type and/or class of stationery designs; the voting module to identify a set of stationery to be provided to the user based on the association; presentation logic to dynamically generate a graphical user interface (GUI) containing the identified set of stationery designs, the GUI comprising a thumbnail image of each of the stationery designs and a selection element which the user manipulates with a mouse or other cursor control device to rate the stationery image on a specified rating scale; the voting module to receive and compile the ratings of the stationery designs submitted by all users, the ratings used as a factor in determining whether to utilize the stationery designs on the online stationery service.

### BACKGROUND

1. Field of the Invention

This invention relates generally to the field of network data processing systems. More particularly, the invention relates to an improved architecture and method for collecting end user feedback for stationery designs.

2. Description of the Related Art

Web-based systems for designing stationery such as wedding invitations, birth announcements, thank you cards, birthday party invitations, etc, are currently available over the Internet. One such service, provided by the assignee of the present application, can be found at www.tinyprints.com. As illustrated in FIG. 1, this online stationery service allows users to select from a variety of different stationery categories 101. Upon selection of a particular category, multiple stationery design options are provided for that category. The user may then choose a particular stationery design and personalize the design to place a stationery order (e.g., by entering a personalized message, colors, etc).

One issue with current online stationery systems, however, is the difficulty of selecting new stationery designs for the online stationery website. Currently, prospective designs are submitted by groups of internal and external designers (i.e., “internal” and “external” in relation to the stationery service). A merchandising team at the online stationery service must then review the designs and select a subset of the designs for use within the online stationery website. Given that there may be hundreds of design submissions for a given stationery category, selecting a subset of stationery designs is a difficult, time consuming task. In this scenario, feedback from certain end users of the online stationery service would be beneficial.

Consequently, what is needed is an automated, efficient system and method for collecting feedback from end users.

### SUMMARY

A system and method are described for collecting user feedback on prospective stationery designs. For example, one embodiment of a system implemented within an online stationery service for collecting user feedback on prospective stationery designs is described, the system comprising at least one memory for storing program code and at least one processor for processing the program code to execute: session management logic to establish and maintain an online session with an end user; a voting module to implement a screening test to determine an association between the user and a particular type and/or class of stationery designs; the voting module to identify a set of stationery to be provided to the user based on the association; presentation logic to dynamically generate a graphical user interface (GUI) containing the identified set of stationery designs, the GUI comprising a thumbnail image of each of the stationery designs and a selection element which the user manipulates with a mouse or other cursor control device to rate the stationery image on a specified rating scale; the voting module to receive and compile the ratings of the stationery designs submitted by all users, the ratings used as a factor in determining whether to utilize the stationery designs on the online stationery service.

### BRIEF DESCRIPTION OF THE DRAWINGS

A better understanding of the present invention can be obtained from the following detailed description in conjunction with the following drawings, in which:

FIG. 1 illustrates a home page of a stationery service owned and operated by the assignee of the present application.

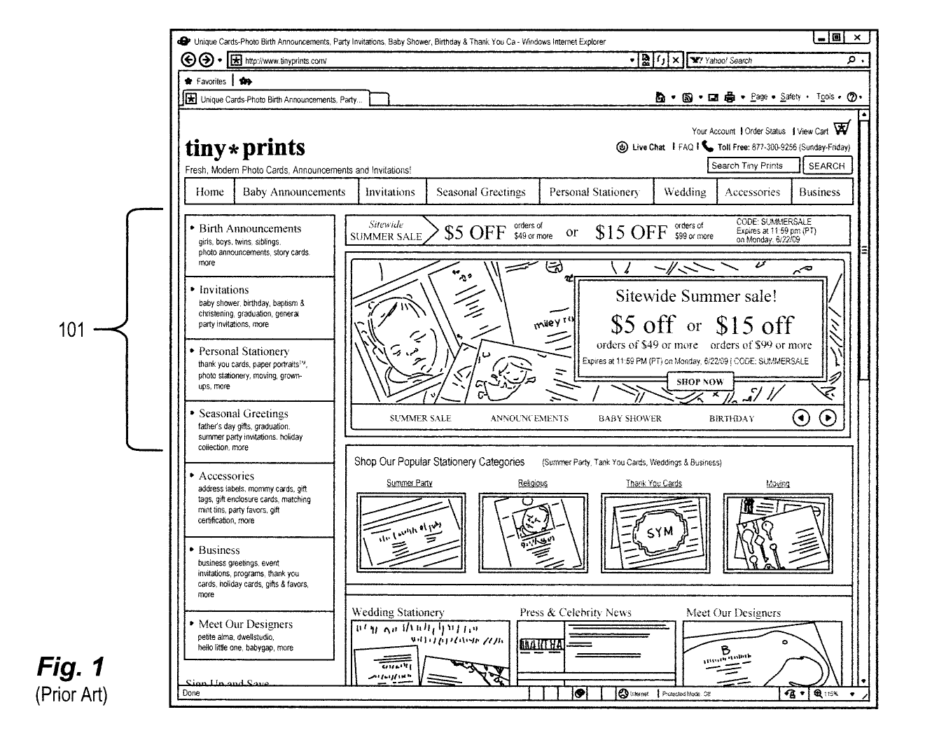

FIG. 2 illustrates one embodiment of a method for selecting new stationery designs.

FIG. 3 illustrates a system architecture according to one embodiment of the invention.

FIG. 4 illustrates one embodiment of a method for polling users on stationery designs.

FIG. 5 illustrates one embodiment of a graphical user interface (GUI) for selecting users for a stationery design poll.

FIGS. 6a-c illustrate different techniques for inviting users to participate in a stationery design poll.

FIGS. 7a-b illustrate a screening test employed on one embodiment of the invention to determine a user's preferences.

FIG. 8 illustrates a window for collecting user data according to one embodiment of the invention.

FIG. 9 illustrates an email message inviting a user to vote on stationery designs.

FIG. 10 illustrates a graphical user interface (GUI) for voting on stationery designs.

FIG. 11 illustrates another GUI for voting on stationery designs.

FIG. 12 illustrates a GUI showing a set of stationery designs for which voting is completed.

FIG. 13 illustrates a plurality of different ratings for stationery designs.

FIG. 14 illustrates an email message inviting a user to review current ratings for stationery designs.

FIG. 15 illustrates a GUI showing a set of stationery designs and an indication of those stationery designs which have been selected.

### DETAILED DESCRIPTION OF PREFERRED EMBODIMENTS

Described below is a system and method for collecting user feedback on stationery designs. Throughout the description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

It should be noted that the term “stationery” is used herein to refer to cards, invitations (e.g., wedding, birthday invitations, etc), and any other form of written communication and/or images printed on a medium (e.g., paper, fabric, etc) using any form of printing device.

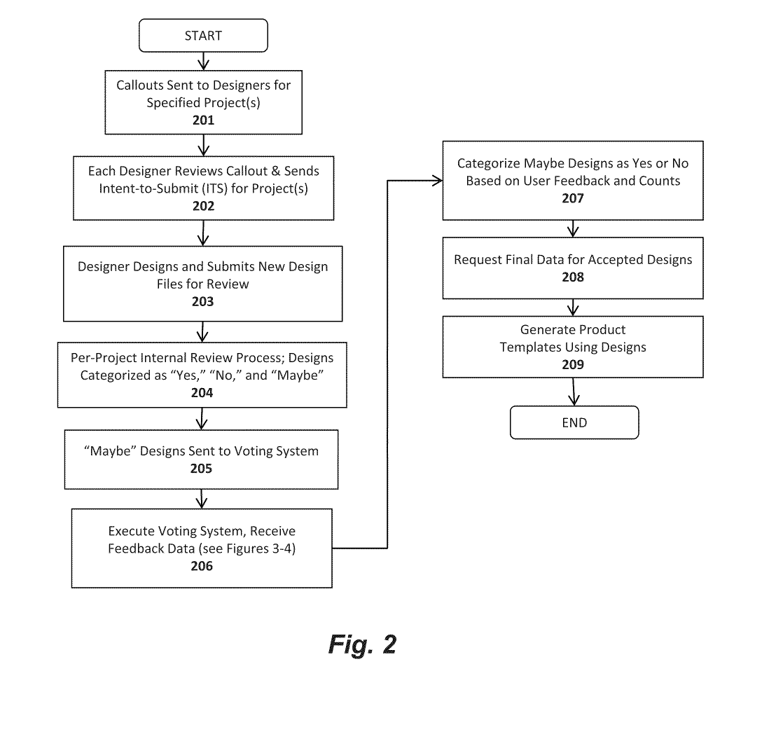

FIG. 2 illustrates one embodiment of a method for selecting new stationery designs. At 201, callouts are sent to designers for specific projects. As used herein, a “project” is a series of transactions to identify a specific set of stationery designs based on variables such as occasion, format or stationery size. In one embodiment, the “callout” comprises a series of email messages transmitted to the designers associated with a particular project. The designers for a project may be selected manually by members of the online stationery service, or automatically, based on the designer's specialties and/or preferences.

Regardless of how the designers are identified, at 202, each designer selected for the project reviews the callout and, if interested, responds with an intent-to-submit (ITS) designs for the requested project(s). In one embodiment, a reminder email is automatically transmitted to those designers who have not responded for a predetermined period of time.

At 203, the designer submits new stationery designs for review. In one embodiment, the designs are submitted in the form of an Adobe Illustrator (Al) file as described in the co-pending application entitled System And Method For Designing And Generating Online Stationery, Ser. No. 12/188,721, filed Aug. 8, 2008, which is assigned to the assignee of the present application and which is incorporated herein by reference.

At 204, an internal merchandizing team of the online stationery service reviews all pending designs submitted for the project and categories the designs as “Yes” (i.e., design accepted), “No” (i.e., design rejected), and “Maybe” (i.e., more information needed). Some of the stationery designs categorized as “Maybe” are sent back to their respective designers with comments and/or suggestion for changes. In addition, in one embodiment of the invention, the designs are sent to a user voting system implemented within the online stationery service, described in detail below. Briefly, the voting system collects feedback from end users on certain stationery designs. In one embodiment, user preferences are determined through a screening test and stationery designs are sent to users based on the results of the screening test.

Thus, returning to the method shown in FIG. 2, at 206, the voting system is executed to collect feedback from the selected users. As described below, in one embodiment, each user selected for voting receives an email message which includes a hyperlink to the online stationery service voting website. The hyperlink uniquely identifies each user. Thus, upon selection of the link, a Web page containing a specific set of designs is generated and transmitted to the end user's browser (as described below). The user then reviews the stationery designs and submits feedback to the online stationery service.

At 207, the merchandising team at the online stationery service reviews the existing design candidates (i.e., the “Maybe” group) in light of the feedback received from the various users and the remaining designs are re-characterized to “Yes” (accepted) or “No” (not accepted).

At 208, the online stationery service requests any final data which may be needed to build a stationery product template from the selected designs and, at 209, the product templates are generated using the designs.

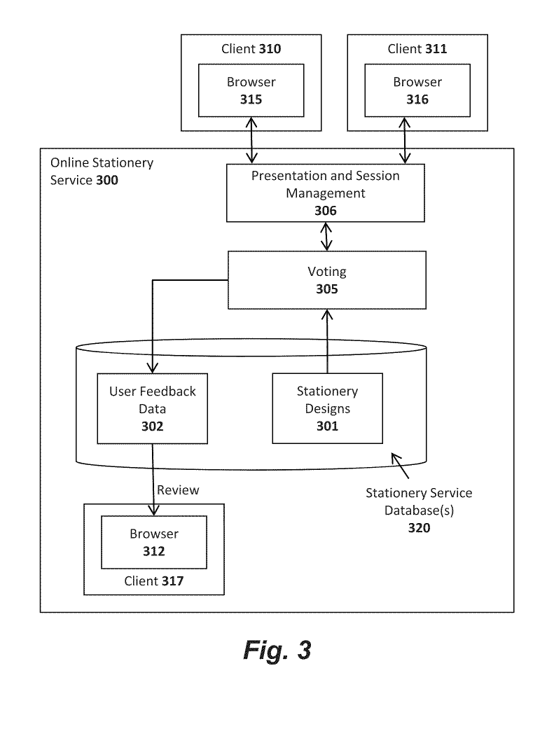

FIG. 3 illustrates one embodiment of a voting system architecture for collecting feedback from end users. In one embodiment, presentation and session management logic 306 executed within the online stationery service 300 establishes network communication sessions with users and generates the different graphical user interface (GUI) features described herein. Various well known functional modules associated within the presentation and session management logic 306 are executed to receive input, process the input, interact with one or more other modules shown in FIG. 3, and dynamically generate Web pages containing the results. The Web pages are then transmitted to the users' client computers' 310, 311 and rendered on browsers 315, 316. The Web pages may be formatted according to the well known HyperText Markup Language (“HTML”) or Extensible HTML (“XHTML”) formats, and may provide navigation to other Web pages via hypertext links. One embodiment utilizes Dynamic HTML (“DHTML”), a collection of technologies used together to create interactive Web sites by using a combination of a static markup language (e.g., HTML), a client-side scripting language (e.g., JavaScript), a presentation definition language (e.g., CSS), and the Document Object Model (“DOM”).

A voting module 305 executed on servers within the online stationery service performs the various voting operations described herein using stationery designs 301 stored within a database 320 (i.e., designs within the “Maybe” group). The voting module 305 assigns stationery designs to be reviewed by users based on user preferences and/or demographic information. In one embodiment, the voting module 305 implements a screening test to determine a user's preferences. The voting module 305 then assigns sets of stationery to be reviewed by each user based on the results of the screening test and/or demographic information related to the end user. By way of example, if a user's screening test identifies the user as preferring “modern” stationery types, and/or if the demographic information associated with the user indicates that the user would be best suited to review “modern” stationery types, then the voting module 305 may send the user “modern” stationery designs for review. Of course, the underlying principles of the invention are not limited to any particular user selection mechanism.

Regardless of how the stationery designs are selected, in one embodiment, users are invited to join in the voting process through email messages which include hyperlinks to the online stationery service 300. In response to selecting the link, a series of Web pages containing images of the stationery designs are transmitted to the users' client computers 310, 311 and rendered on browsers 315, 316. Various examples of Web-based graphical user interfaces for voting on stationery designs are provided below. Each user's design selections are compiled by the voting module 305 and stored as user feedback data 302 within the stationery service database 320. The combined feedback data from all users is then reviewed internally at the online stationery service to make a determination on a final set of stationery designs. In one embodiment, the review processes is done using clients 317 equipped with Web browsers 312, although various other technologies for reviewing the user feedback data 302 may also be employed.

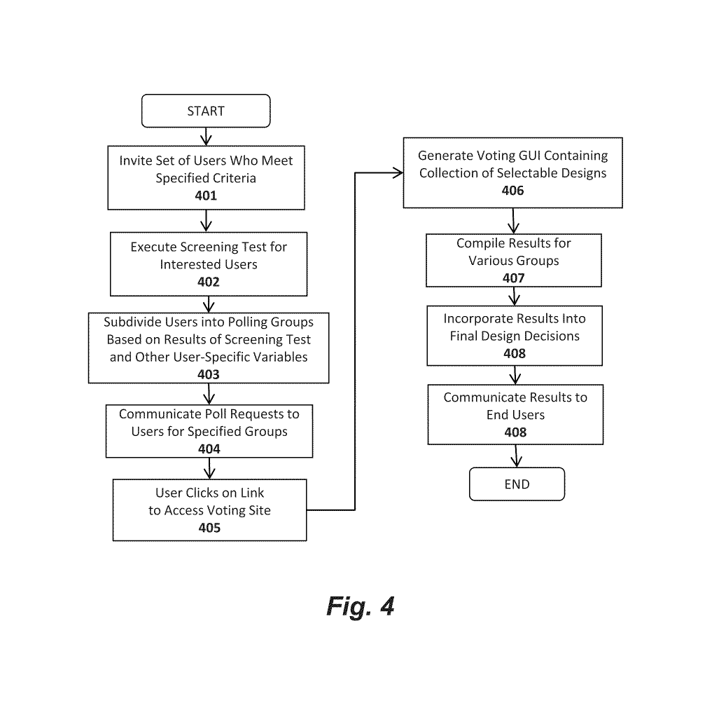

FIG. 4 illustrates a method implemented in accordance with one embodiment of the invention. Wile the method in FIG. 4 will be described within the context of the system architecture illustrated in FIG. 3, it should be noted that the underlying principles of the invention are not limited to this architecture.

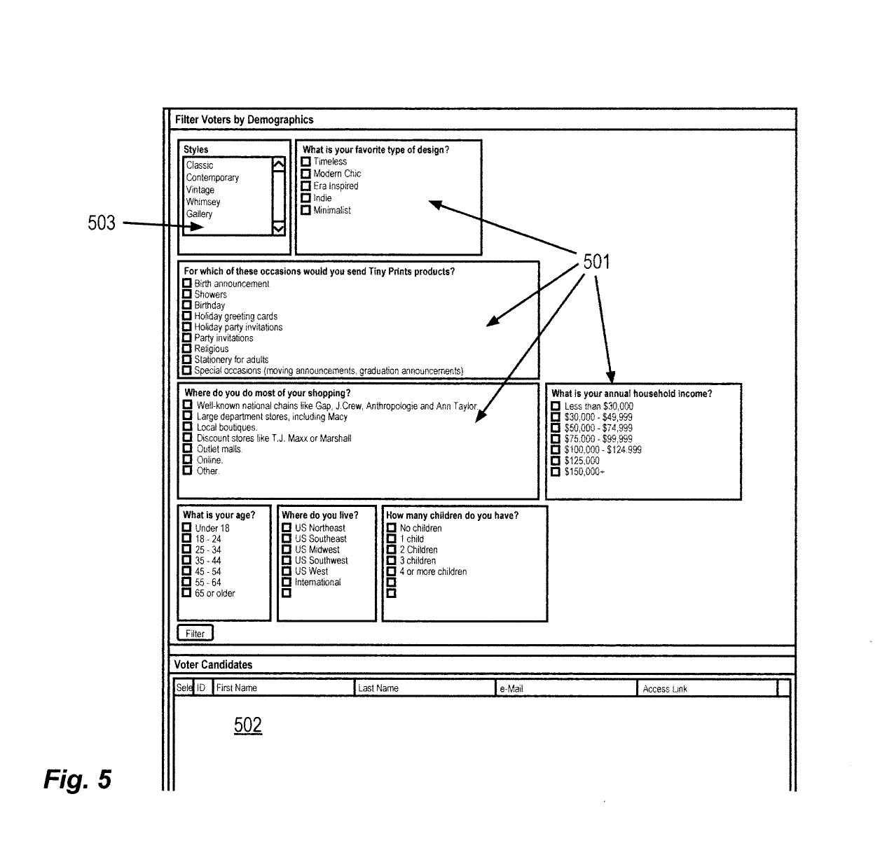

At 401, a set of users are invited to participate in the voting process. The set of users may be selected in various ways. For example, the set may simply be all users who have an account established on the online stationery service 300 and/or who have shown an interest in participating. FIG. 5 illustrates one embodiment of a graphical user interface (GUI) for selecting users to review different stationery styles. A plurality of groups of selection boxes are provided 501 to identify users corresponding to certain demographic data. In this example, it is assumed that the users have already responded to a set of questions. For example, the demographic data illustrated in FIG. 5 includes a user's favorite design type; the occasions for which a user purchases stationery; the places where a user shops; the user's annual income; the user's age and geographical location; and the number of children. Selecting one or more check boxes from each of the groups causes a list of users 502 meeting the selected criteria to be generated towards the bottom of the screen (all other users being filtered out). It should be noted, however, that the underlying principles of the invention are not limited to any mechanism for selecting a set of users. In one embodiment, once a set of users have been selected, they may be associated with (and selected to review) one or more stationery styles 503. In the example shown in FIG. 5, the styles include “Classic,” “Contemporary,” “Vintage,” “Whimsy,” and “Gallery.” It should be noted, however, that the underlying principles of the invention are not limited to any particular set of styles.

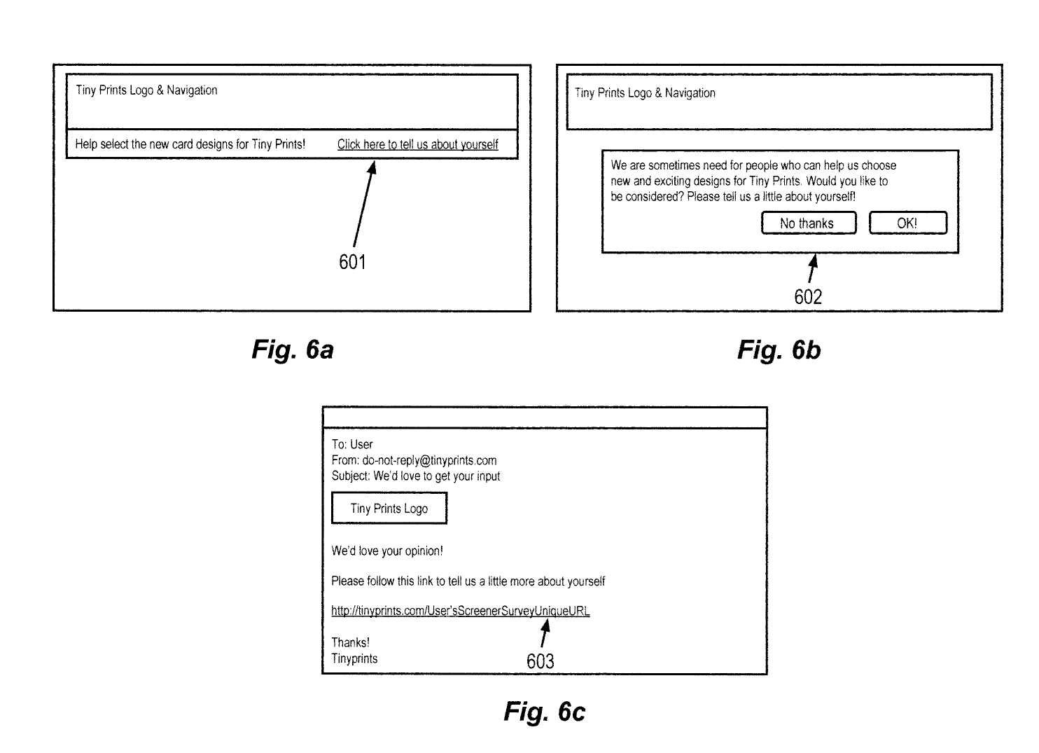

Once the set of users is selected, user invitations may be communicated as a link 601 within a Web page as shown in FIG. 6a, a pop up window 602 as shown in FIG. 6b or an email message containing a hyperlink 603 as shown in FIG. 6c. Upon acceptance of the invitation, the user is taken to a Web page to initiate a screening test and/or collect additional information about the user's preferences.

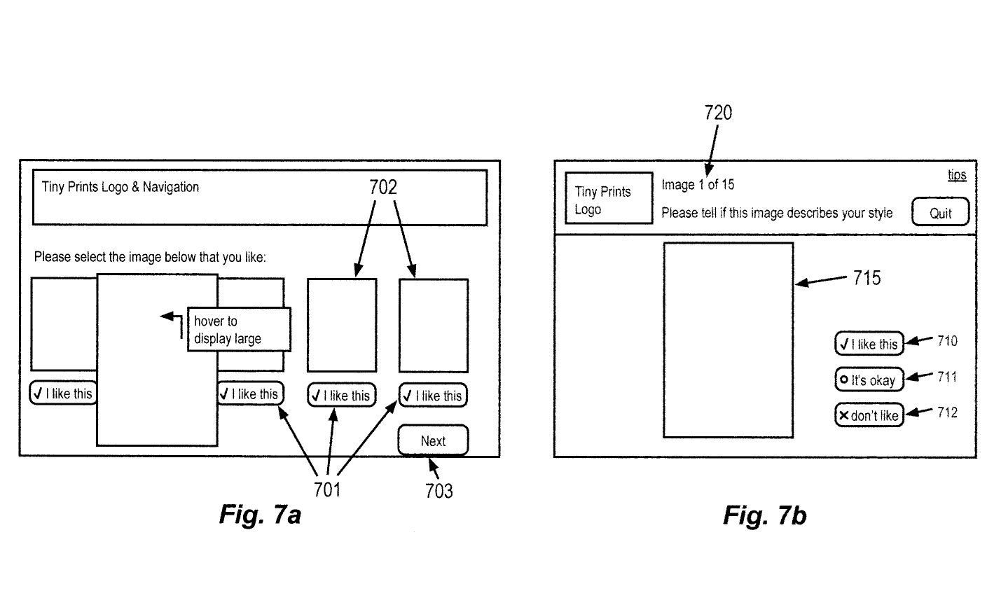

At 402, a screening test is executed to determine the types and/or classes of stationery to be reviewed by the user. One embodiment of a screening test is illustrated in FIGS. 7a-b. As illustrated in FIG. 7a, one embodiment of the screening test comprises a series of stationery images 702 arranged in a sequence across the Web page (or other graphical data structure). Underneath each stationery image is a selection element 701 which the user may manipulate with a mouse or other cursor control device to rate the stationery image. In one embodiment, three different values are used to rate the stationery images: (1) “I like this,” (2) “it's OK,” and (3) “don't like.” The selection element 701 of this embodiment may be implemented as a drop down menu or other multi-option selection graphic listing all possible rating options. The user simply selects one of the rating options to rate the stationery image.

FIG. 7b illustrates an alternate embodiment in which stationery images 715 are displayed one at a time, in succession, within Web pages. An indicator 720 at the top of the page indicates the number of the current stationery image and the total number of images to be reviewed (i.e., so that the user can view his/her progress). A group of graphical buttons are provided to allow the user to rate each image. In one embodiment hovering the cursor over the image provides a larger image display. In one embodiment, the buttons include the same options mentioned above: (1) “I like this,” (2) “it's OK,” and (3) “don't like.” Upon selection of a button, the next stationery image in sequence is displayed for the end user. The process continues in this manner until each stationery design has been reviewed.

The results of the screening test are transmitted to the voting module 305, which uses this information to associate the user with a particular type of stationery. For example, if the user has a tendency to prefer (or to be better suited at choosing) “classic” stationery designs, then the voting module 305 will allow the user to vote on “classic” stationery designs. To enable this operation, one embodiment of the invention sub-divides stationery designs into the following categories: classic, contemporary, vintage, photo-centric, whimsy, and gallery.

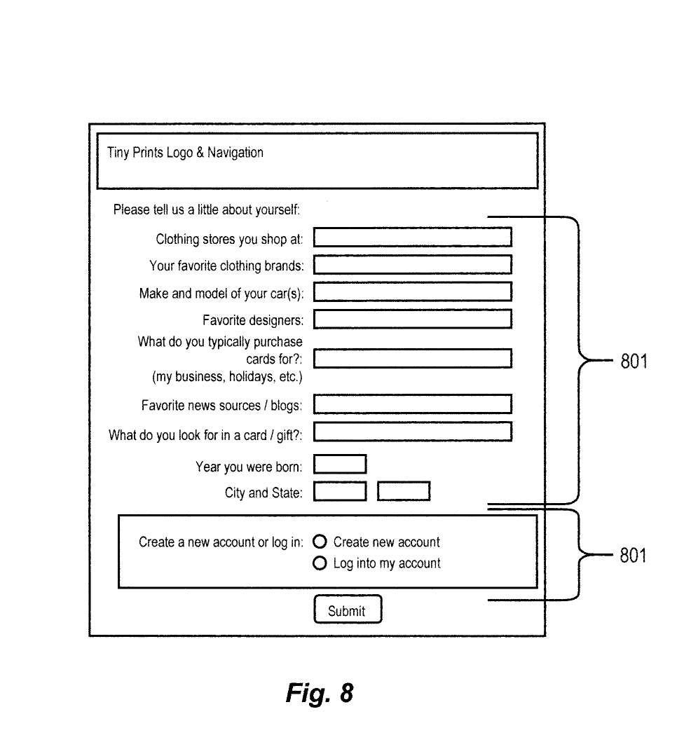

In one embodiment, in addition to the screening test, the user is prompted to answer a series of questions related to the user's preferences. FIG. 8 illustrates an exemplary series of questions 801 which include preferred clothing stores, clothing brands, make and model of the user's car, card purchase information, news sources, the user's age and income, the year and location of the user's birth, etc. This demographic information is then used by the voting module 305 when selecting users for a particular class of stationery. User's meeting certain demographic criteria may also be selected manually using the GUI shown in FIG. 5. The user is also provided options within selection region 802 to log in to the online stationery website with an existing account or to create a new account.

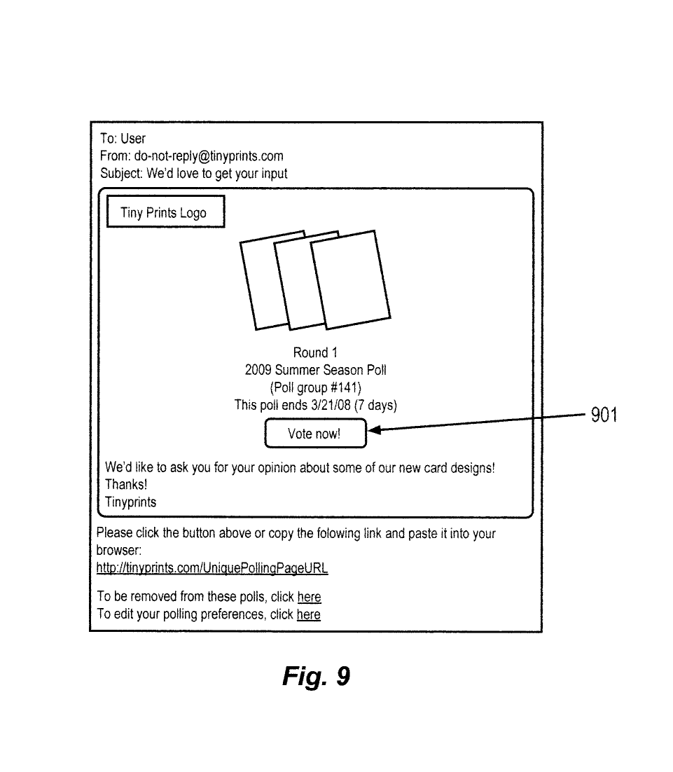

FIG. 9 illustrates an email message inviting an end user to participate in a particular stationery design poll. The email specifies the name of the poll (“Round 1, 2009 Summer Season Poll”), an indication of the poll group to which the user belongs (“Poll Group #141”), and the date on which the poll ends (“Mar. 12, 2008”). A button containing a hyperlink 901 is provided to direct the user to the online stationery service voting website. In one embodiment, the hyperlink 901 uniquely identifies the user. In response to selection of the hyperlink, the voting module 305 generates a poll uniquely tailored to the user, based on the results of the screening test and/or the user's specified preferences.

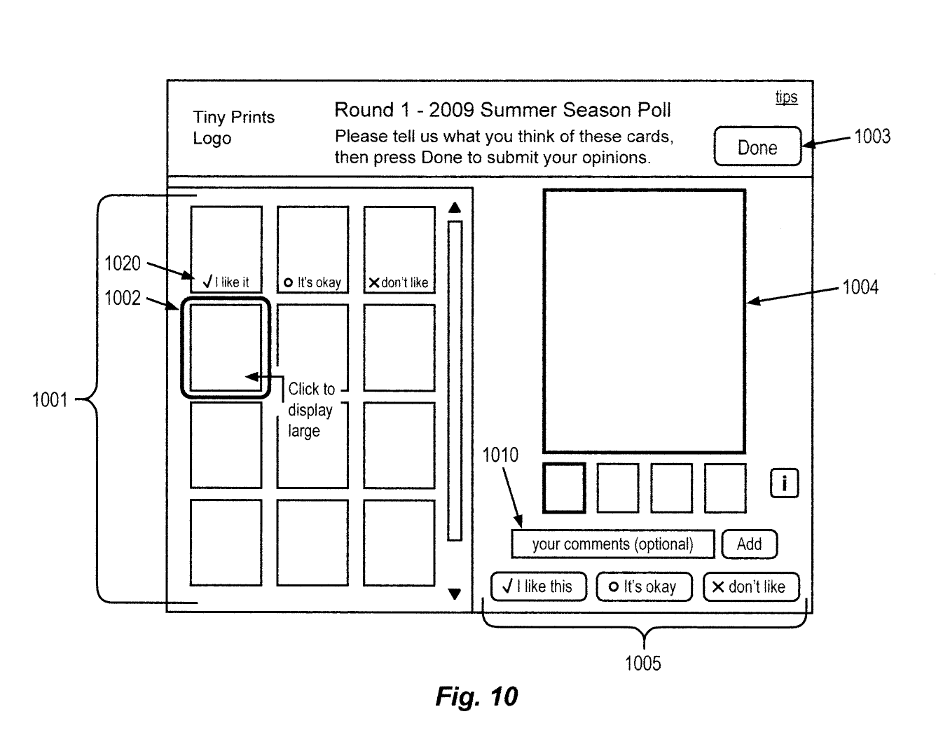

One embodiment of a graphical user interface (GUI) for collecting user input on stationery designs is illustrated in FIG. 10. In one embodiment, the GUI is a Web page dynamically generated by the presentation and session management logic 306 and using stationery designs identified by the voting module 305. The GUI includes a region of thumbnail images 1001 of each of the stationery designs. A user selects a particular design by clicking on the design via a mouse or other cursor control device. In response, the thumbnail of the design is highlighted (e.g., as shown by highlight element 1002 in FIG. 10) and the corresponding design is displayed within a display region 1004. The user may then add comments on the design via a data entry field 1010 and may rate the design via a group of selectable options 1005. In the specific example shown in FIG. 10, three rating options are provided: (1) “I like this,” (2) “it's OK,” and (3) “don't like.” Once a user rates a design, an indication of the rating 1020 is displayed within the thumbnail image. While only three rating options are illustrated in FIG. 10, various other/additional rating types may be employed while still complying with the underlying principles of the invention. For example, in one embodiment, the user is asked to rate designs on a numeric scale (e.g., from 1 to 5). A “done” button 1003 is provided to complete the process of voting on stationery designs.

In one embodiment, when the GUI is initially rendered within the user's browser, the first stationery design in the sequence is highlighted (e.g., with a thumbnail in the upper left corner of region 1001) and the image corresponding to the design is displayed within the display region 1004. As each design is rated via rating options 1005, the next thumbnail in succession is automatically selected (i.e., moving from left to right in region 1001) and the next corresponding stationery design is displayed within display region 1004. The process continues in this manner until the final design is rated.

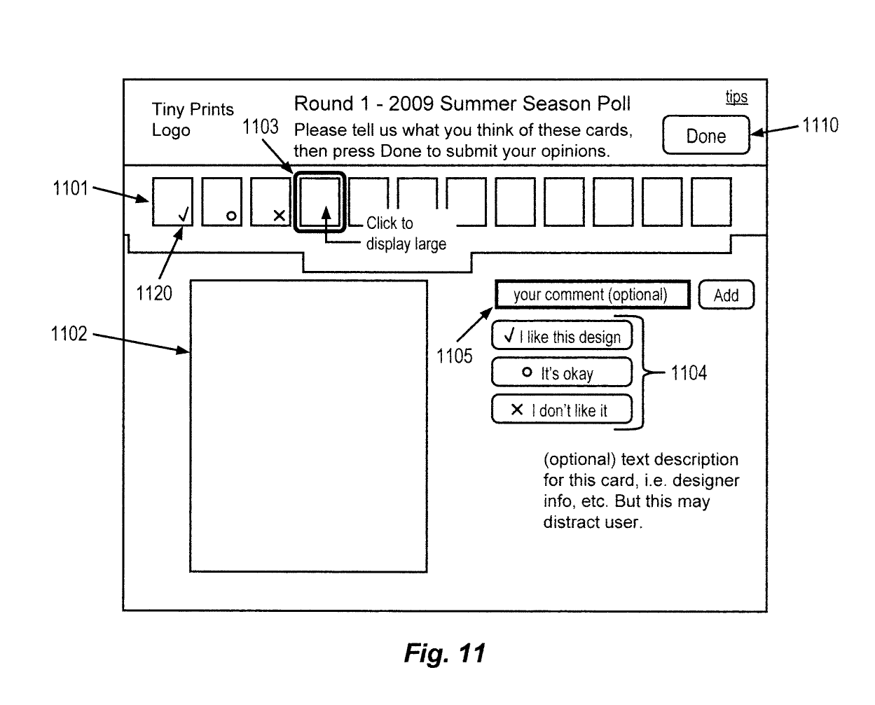

FIG. 11 illustrates another embodiment of a GUI for collecting user feedback on stationery designs. In this embodiment, the thumbnail images 1101 are arranged horizontally towards the top of the GUI. When a particular thumbnail image 1103 is highlighted via a mouse or other cursor control device, the stationery design image corresponding to the thumbnail image is displayed within display region 1102. The user may then add comments on the design via a data entry field 1105 and may rate the design via a group of selectable options 1004. In the specific example shown in FIG. 11, three rating options are provided: (1) “I like this,” (2) “it's OK,” and (3) “don't like.” Once a user rates a design, an indication of the rating 1120 appears within the thumbnail image. A “done” button 1110 is provided to complete the process of voting on stationery designs. As in the design shown in FIG. 10, various other rating techniques may be provided while still complying with the underlying principles of the invention (e.g., a numerical rating from 1-10).

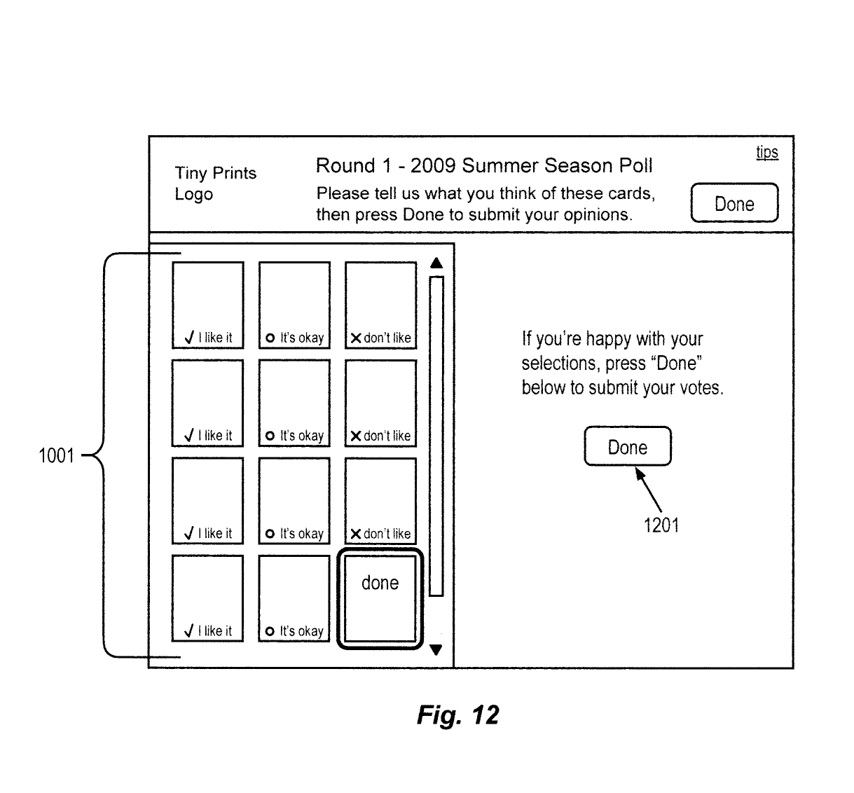

In addition, in one embodiment, when the GUI is initially rendered within the user's browser, the first design in the sequence is highlighted (e.g., with a thumbnail in the upper left corner) and the image corresponding to the design is displayed within the display region 1102. As each design is rated via rating options 1104, the next thumbnail in succession is automatically selected (i.e., moving from left to right in the thumbnail region) and the next corresponding stationery design is displayed within display region 1102. The process continues in this manner until the final design is rated. FIG. 12 illustrates a “done” button 1201 displayed when the review process is complete.

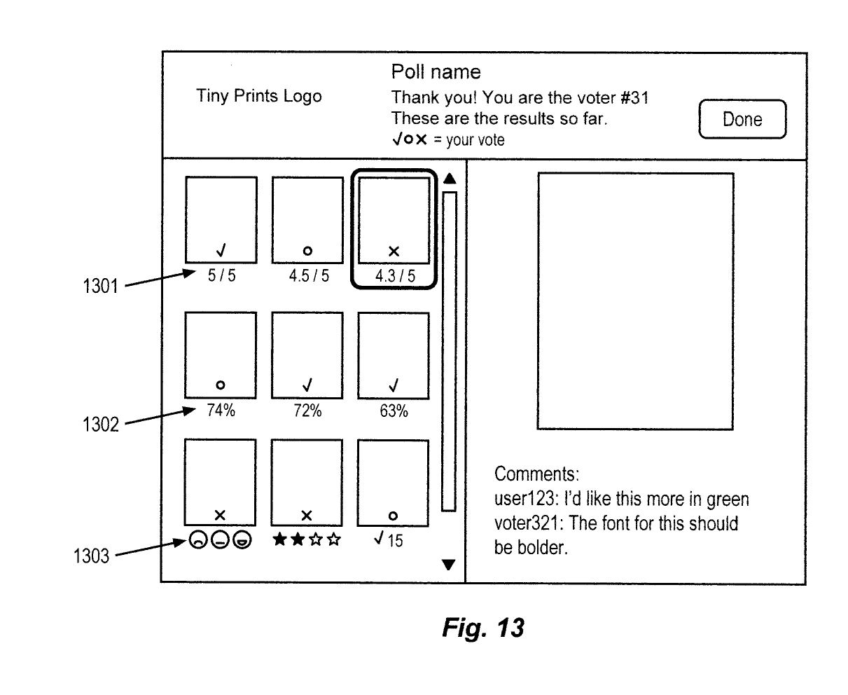

As illustrated in FIG. 13, in one embodiment, when the user has completed submitting input, the combined voting results for each stationery design are displayed for the user. In one embodiment, the voting results are displayed beneath each stationery design within the plurality of thumbnail images. As illustrated at 1301, one embodiment of a rating comprises a number value (here a value of between 1-5). At 1302, a percentage rating is shown and at 1303 a graphically-displayed numerical value is shown.

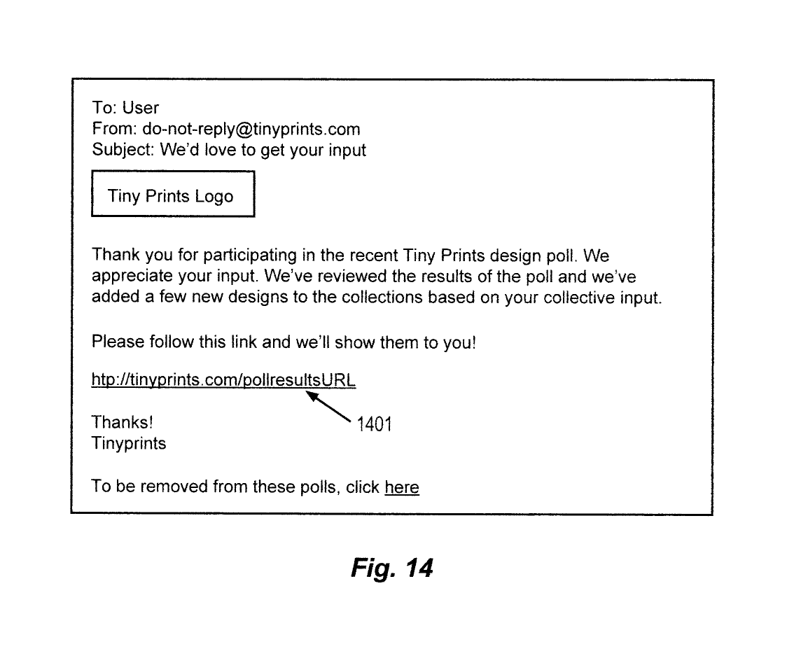

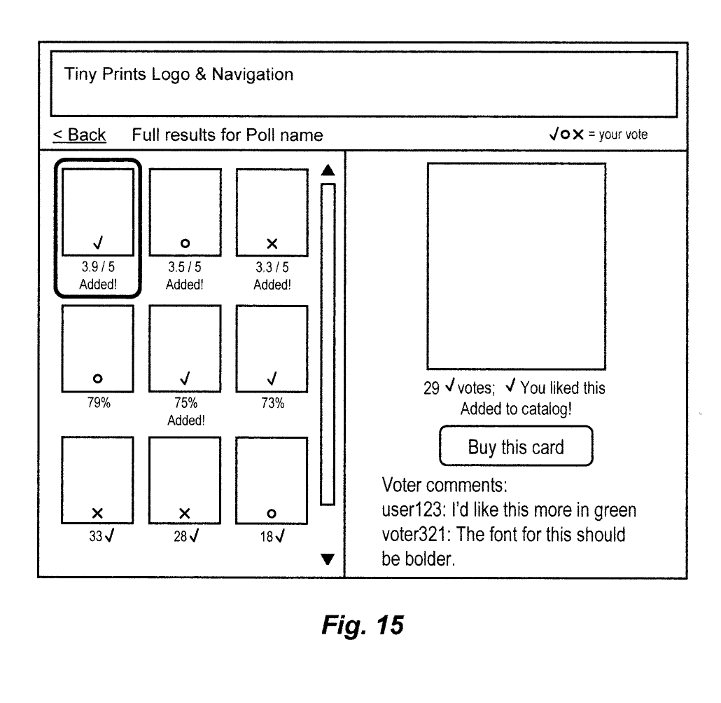

As illustrated in FIG. 14, in one embodiment, an email is sent to the end user when voting is complete for a particular stationery poll. A hyperlink 1401, when selected, directs the end user to an online stationery service website comprised of a set of designs and associated ratings. FIG. 15 shows one embodiment in which, in addition to a numerical rating value, an indication as to whether the stationery design has been added to the online stationery website is provided.

Throughout the discussion above, various details have been omitted to avoid obscuring the pertinent aspects of the invention. For example, in an embodiment of the invention in which the user connects to the online stationery service 300 via a Web browser, various well known functional modules associated within the user session logic 333 and promotions administrator logic 350 shown in FIG. 3 are executed to receive input, process the input and dynamically generate Web pages containing the results. The Web pages may be formatted according to the well known HyperText Markup Language (“HTML”) or Extensible HTML (“XHTML”) formats, and may provide navigation to other Web pages via hypertext links. Web pages are requested, dynamically generated, and transmitted from Web servers on the online stationery service 300 using the Hypertext Transfer Protocol (HTTP). One embodiment of the invention employs application software written in PHP (a well known scripting language designed for producing dynamic web pages) running on Apache™ Web servers served off Linux platforms. In addition, in one embodiment, the databases described herein are MySQL databases. It should be noted, however, that the underlying principles of the invention are not limited to any particular type of communications protocol or network architecture.

Embodiments of the invention may include various steps as set forth above. The steps may be embodied in machine-executable instructions which cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. For example, it will be readily apparent to those of skill in the art that the functional modules such as wizards and other logic may be implemented as software, hardware or any combination thereof. Accordingly, the scope and spirit of the invention should be judged in terms of the claims which follow.

What is claimed is:

1. A system implemented within an online stationery service for collecting user feedback on prospective stationery designs, the system comprising at least one memory for storing program code and at least one processor for processing the program code to execute:
session management logic to establish and maintain an online session with an end user;
a voting module to implement a screening test to determine an association between the user and a particular type and/or class of stationery designs;
the voting module to identify a set of stationery to be provided to the user based on the association;
presentation logic to dynamically generate a graphical user interface (GUI) containing the identified set of stationery designs, the GUI comprising a thumbnail image of each of the stationery designs and a selection element which the user manipulates with a mouse or other cursor control device to rate the stationery image on a specified rating scale;
the voting module to receive and compile the ratings of the stationery designs submitted by all users, the ratings used as a factor in determining whether to utilize the stationery designs on the online stationery service.

2. The system as in claim 1 wherein the graphical user interface comprises a dynamically generated Web page.

3. The system as in claim 1 wherein the GUI comprises a sequence of thumbnail images and a stationery design display region, wherein upon selection of a particular thumbnail image, the stationery design image corresponding to the selected thumbnail image is displayed within the display region.

4. The system as in claim 1 wherein the selection element includes three selectable ratings for each stationery design.
